(19) United States
(12) Patent Application Publication
(10) Pub. No.: US 2012/0166762 A1
(43) Pub. Date: Jun. 28, 2012

(54) COMPUTING APPARATUS AND METHOD BASED ON A RECONFIGURABLE SINGLE INSTRUCTION MULTIPLE DATA (SIMD) ARCHITECTURE

(76) Inventors: Jae Un Park, Seoul (KR); Suk-Jin Kim, Seoul (KR); Scott Mahlke, Ann Arbor, MI (US); Yong-Jun Park, Ann Arbor, MI (US)

(21) Appl. No.: 13/179,367

(22) Filed: Jul. 8, 2011

(30) Foreign Application Priority Data
Dec. 28, 2010 (KR) 10-2010-0136699

(51) Int. Cl. G06F 15/80; G06F 9/02

(52) U.S. Cl. 712/20; 712/22; 712/E09.002

(57) ABSTRACT

Provided are a computing apparatus and method based on SIMD architecture capable of supporting various SIMD widths without wasting resources. The computing apparatus includes a plurality of configurable execution cores (CECs) that have a plurality of execution modes, and a controller for detecting a loop region from a program, determining a Single Instruction Multiple Data (SIMD) width for the detected loop region, and determining an execution mode of the processor according to the determined SIMD width.

### CROSS-REFERENCE TO RELATED APPLICATION

This application claims the benefit under 35 U.S.C. §119(a) of a Korean Patent Application No. 10-2010-0136699, filed on Dec. 28, 2010, in the Korean Intellectual Property Office, the entire disclosure of which is incorporated herein by reference for all purposes.

### BACKGROUND

1. Field

The following description relates to a Single Instruction Multiple Data (SIMD) architecture system.

2. Description of the Related Art

Mobile devices typically require high performance to provide various functions. For example, smart phones that have come into wide use provide functions that require high performance, such as high-speed Internet access, voice recognition, high definition image decoding, video conference, voice call services, and the like.

To achieve the high performance in mobile devices, various types of parallelisms are applied to embedded devices. For example, a Single Instruction Multiple Data (SIMD)-ization is one method for enhancing the performance of devices. However, it is not easy to apply the SIMD to various kinds of applications.

For example, for codes that have multiple pointer accesses or cross-loop dependency it may be difficult to apply the SIMD architecture. Also, because applications allowing SIMD acceleration have a significant portion of code other than the inner-most loop allowing SIMD-ization, accelerating all parts of the application through SIMD-ization is not possible.

Furthermore, past studies have attempted to determine an optimal SIMD width, but have shown different results according to the types of applications. Because different algorithms in the same application have different optimal SIMD widths, a method of supporting various SIMD widths is needed.

### SUMMARY

In one general aspect, there is provided a computing apparatus based on Single Instruction Multiple Data (SIMD) architecture, the computing apparatus including a processor including a plurality of configurable execution cores (CECs) which are capable of processing in a plurality of execution modes, and a controller for detecting a loop region from a program, determining a Single Instruction Multiple Data (SIMD) width for the detected loop region, and determining an execution mode of the processor according to the determined SIMD width.

In a first execution mode, the processor may process the loop region based on a first type SIMD lane comprising a single CEC.

In a second execution mode, the processor may process the loop region based on a second type SIMD lane comprising a plurality of CECs that are chained to each other.

In a third execution mode, the processor may process the loop region while operating as a coarse-grained array.

Each CEC may comprise a function unit (FU) for processing data, and a configuration memory for storing configuration information corresponding to each execution mode.

Each CEC may further comprise a register file in which data is stored, a register file controller for causing one of data stored in a SIMD memory and data stored in the configuration memory to be stored in the register file, an input unit connected to an output of the register file or to an output of another CEC, and providing the FU with the data stored in the register file or data output from the other CEC, and an output unit including an output register that stores output data from the FU, and a bypass for bypassing the output register.

The configuration information may define at least one of a connection relationship of the FUs, data input and output locations of each FU, a location of data that is to be loaded in the register file, and an activation/deactivation state of the bypass.

The controller may load configuration information corresponding to the decided execution mode in the configuration memory.

In another aspect, there is provided a computing method based on a Single Instruction Multiple Data (SIMD) architecture, the computing method including detecting a loop region from a program, determining a Single Instruction Multiple Data (SIMD) width for processing the detected loop region, and determining an execution mode of an array processor including a plurality of Configurable Execution Cores (CECs) based on the determined SIMD width.

The execution mode may comprise a first execution mode in which the array processor processes the loop region based on a first type SIMD lane comprising a single CEC, a second execution mode in which the array processor processes the loop region based on a second type SIMD lane comprising a plurality of CECs that are chained to each other, and a third execution mode in which the array processor processes the loop region while operating as a coarse-grained array.

In another aspect, there is provided a terminal comprising a Single Instruction Multiple Data (SIMD) architecture that is capable of processing instructions in a plurality of processing modes, the terminal including a plurality of processing elements for processing instructions, and a controller for analyzing a loop region of a SIMD instruction to be processed, determining a number of processing elements to process the loop region to achieve a predetermined processing efficiency, and determining a processing mode from the plurality of processing modes based on the number of processing elements determined to process the loop region.

A first processing mode may comprise a SIMD wide mode in which each processing element of the plurality of processing elements simultaneously process a respective instruction.

A second processing mode may comprise a SIMD narrow mode in which at least two processing elements out of the plurality of processing elements simultaneously process the same instruction, and the at least two processing are chained to each other.

A third processing mode may comprise a coarse-grained array (CGA) mode.

The controller may determine the number of processing elements to process the loop region based on whether the loop region is subject to SIMD-ization.

In response to the controller determining the loop region is subject to SIMD-ization, the controller may determine a SIMD width that corresponds to the number of processing elements that are determined to simultaneously process the loop region.

Other features and aspects may be apparent from the following detailed description, the drawings, and the claims.

### BRIEF DESCRIPTION OF THE DRAWINGS

FIG. 1 is a diagram illustrating an example of a computing apparatus.

FIG. 2 is a diagram illustrating an example of a configurable execution core (CEC).

FIG. 3 is a diagram illustrating an example of a computing apparatus that is in a first execution mode.

FIG. 4 is a diagram illustrating an example of a computing apparatus that is in a second execution mode.

FIG. 5 is a diagram illustrating an example of a computing apparatus that is in a third execution mode.

FIG. 6 is a flowchart illustrating an example of a computing method.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems is described herein may be suggested to those of ordinary skill in the art. Also, descriptions of well-known functions and constructions may be omitted for increased clarity and conciseness.

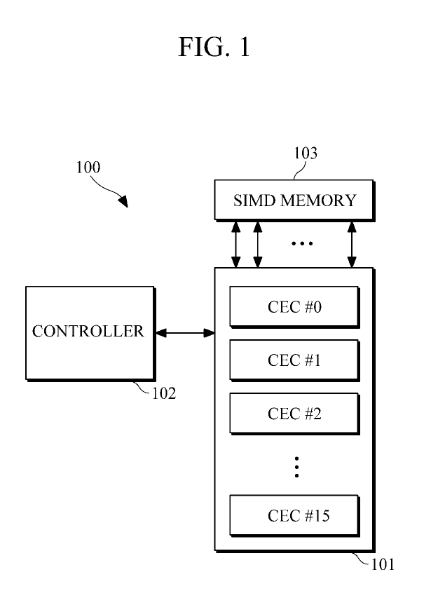

FIG. 1 illustrates an example of a computing apparatus.

Referring to FIG. 1, computing apparatus 100 includes a processor 101, a controller 102, and a Single Instruction Multiple Data (SIMD) memory 103. The computing apparatus 100 may be or may be included in a terminal, for example, a computer, a mobile terminal, a smart phone, a laptop computer, a personal digital assistant, a tablet, an MP3 player, and the like.

The processor 101 includes a plurality of Configurable Execution Cores (CECs). Each CEC may be a processing unit that has a structure and/or an architecture that can change based on configuration information. For example, the processor 101 may include a plurality of reconfigurable processing units and interconnections between the reconfigurable processing units.

The processor 101 may have a plurality of execution modes, for example, two execution modes, three execution modes, four execution modes, and the like. For example, the execution modes of the processor 101 may be classified into a SIMD mode and a non-SIMD mode. The SIMD mode may further be divided into a wide SIMD mode and a narrow SIMD mode. In this example, the wide SIMD mode is referred to as a first execution mode, the narrow SIMD mode is referred to as a second execution mode, and the non-SIMD mode is referred to as a third execution mode.

In the SIMD mode, the processor 101 may operate based on SIMD architecture. For example, in the SIMD mode, each CEC of the processor 101 may receive an instruction and data from the SIMD memory 103 and may process the instruction and the data.

In the non-SIMD mode, the processor 101 may operate based on coarse-grained array (CGA) architecture. For example, in the non-SIMD mode, each CEC of the processor 101 may receive an instruction and data from a separate configuration memory other than the SIMD memory 103, and may process the instruction and the data.

For example, in the wide SIMD mode, the processor 101 may execute an instruction using a first type SIMD lane, and in the narrow SIMD mode, the processor 101 may execute an instruction using the first type SIMD lane or a second type SIMD lane. In this example, a SIMD lane may be a processing unit or a datapath including a plurality of processing units that process a task based on SIMD architecture. The SIMD lane may be a processing unit or datapath that executes the same instruction when a task is processed based on SIMD architecture. For example, in 16-lane SIMD architecture, data may be processed in parallel through 16 datapaths or 16 processing units.

A first type SIMD lane is a SIMD lane that includes a single CEC. In the wide SIMD mode in which an instruction is executed using the first type SIMD lane, a CEC may be one-to-one mapped to a SIMD lane. For example, in FIG. 1, the processor 101 may configure 16 first type SIMD lanes using each of CEC #0 through CEC #15.

A second type SIMD lane is a SIMD lane that includes a plurality of chained CECs. In this example, the term “chaining” refers to a structure in which a plurality of CECs are connected to each other in such a manner that the output of a prior CEC becomes an input of a next CEC. In the narrow SIMD mode in which an instruction is executed using the second type SIMD lane, a plurality of CECs may be mapped to a single SIMD lane. For example, in FIG. 1, the output of CEC#0 may be connected to an input of CEC#1 to form a SIMD lane.

The controller 102 may detect a loop region from a program, and determine an optimal SIMD width for the detected loop region. A SIMD width corresponds to the number of operating units for simultaneously processing a SIMD instruction used to process a loop region. In various aspects described herein, SIMD-ization may modify codes of an instruction in order to process the instruction based on SIMD architecture. Analysis on the code of an instruction may be used to determine an optimal number of datapaths for efficient SIMD-ization. The optimal number of datapaths for efficient SIMD-ization depends on the characteristics of a program. Based on the code analysis results, an optimal number of datapaths or SIMD modules for most efficiently processing the corresponding instruction may be obtained. The optimal number of datapaths or SIMD modules may be defined as a SIMD width.

As another example, analysis on the code of an instruction may be used to determine a number of datapaths processing data at or above a predetermined threshold instead of the optimal number of datapaths. That is, the number of datapaths may be determined to achieve a predetermined processing efficiency which may or may not be an optimal processing efficiency.

After the SIMD width for the loop region is determined, the controller 102 may determine an execution mode of the processor 101 based on the SIMD width for the loop region. For example, the controller 102 may modify the structure or configuration of the processor 101 such that the loop is processed in at least one execution mode described herein such as the first, second, and third execution modes.

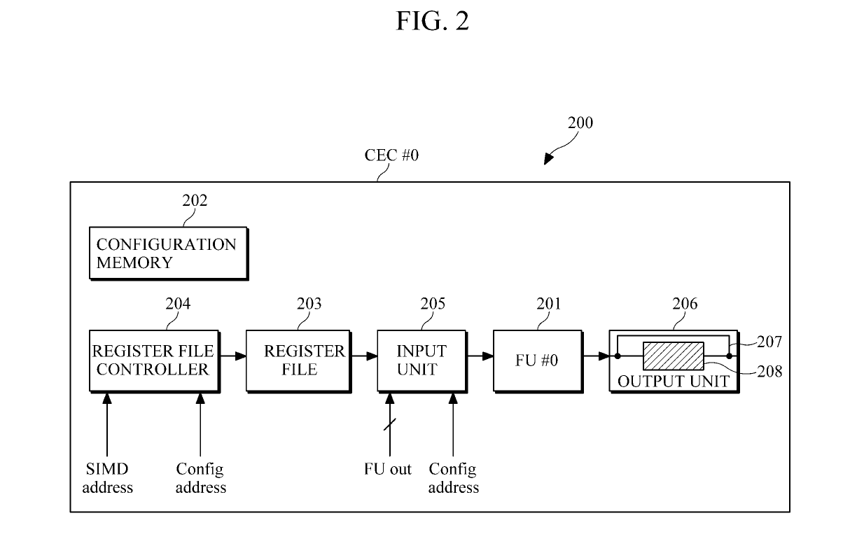

FIG. 2 illustrates an example of a configurable execution core (CEC).

Referring to FIGS. 1 and 2, CEC 200 includes a functional unit (FU#0) 201, a configuration memory 202, a register file 203, a register file controller 204, an input unit 205, and an output unit 206. The CEC 200 is an example of the CECs illustrated in FIG. 1.

The FU#0 201 may execute instructions and process data. For example, the FU#0 201 may include an arithmetic/logic unit.

The configuration memory 202 may store configuration information corresponding to an execution mode of the processor 101. For example, the configuration information may define a connection relationship of FUs, data input and output locations of the FUs, locations of data that is to be loaded to the register file 203, and an activation/deactivation state of a bypass 207.

The register file 203 may store data to be processed by the FU#0 201.

The register file controller 204 may determine data that is stored in the register file 203. For example, the register file controller 204 may determine at least one data stored in the SIMD memory 103 and/or data stored in the configuration memory 202, and store the determined at least one data in the register file 203.

In this example, the input unit 205 is connected to both the output of the register file 203 and the output of another FU (for example, FU#1 of CEC#1). For example, the input unit 205 may select one from among the output of the register file 203 and the output of the other FU, as an input, according to configuration information of the configuration memory 202. The input selected by the input unit 205 may be provided to the FU#0 201.

The output unit 206 is connected to the output of the FU#0 201. As an example, the output unit 206 may include an output register 208 for storing the output of the FU#0 201 and the bypass 207 for bypassing the output register 208.

In response to the controller 102 determining the execution mode of the processor 101 and loading configuration information that corresponds to the determined execution mode in the configuration memory 202, the execution mode of the processor 101 and the structure and configuration of the processor 101 may be changed based on the configuration information loaded in the configuration memory 202. For example, based on the configuration information loaded in the configuration memory 202, the output of the FU#0 201 may be connected to or disconnected from a FU of another CEC, for example, FU#1 of CEC#1.

As another example, if 16 CECs are used, configuration information may be 432 bits (=16×(7+14+5+1)). An example of the fields of the configuration information is as follows.

For example, the configuration information may include a 1-bit area for determining whether or not the register file controller 204 will use addresses of the configuration memory 202, a 3-bit area for designating addresses of the configuration memory 202, and a 2-bit area corresponding to each input of the FU#0 201 if the FU#0 201 has two inputs. Also, the configuration information may include a 14-bit area for the FU#0 201. For example, if the FU#0 201 has two inputs, the configuration information may use two 3-bit areas for selecting one from among eight sources, and an 8-bit area for receiving data directly from the configuration memory 202, for each input. Also, the configuration information may include a 5-bit area for various opcodes, and a 1-bit area for determining whether the output unit 206 has to store the output of the FU#0 201 in the output register 208 or to bypass the output of the FU#0 201 around the output register 208.

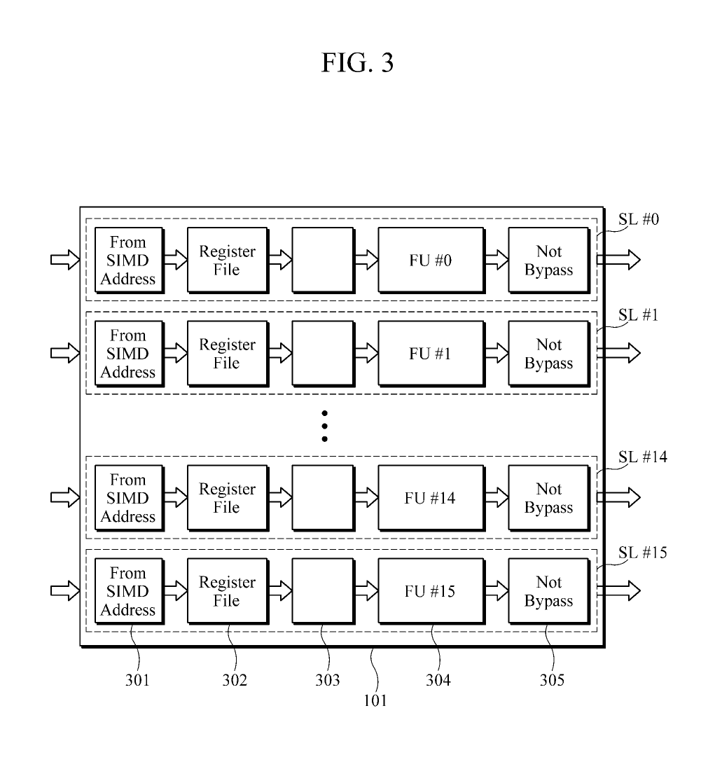

FIG. 3 illustrates an example of a computing apparatus that is in the first execution mode.

Referring to FIGS. 1-3, if an optimal SIMD width for a loop region is equal to the number of CECs, the controller 102 may load configuration information corresponding to the first execution mode such that the processor 101 can process the loop region in the first execution mode.

In the first execution mode, that is, in the wide SIMD mode, the processor 101 may process the loop region using first type SIMD lanes based on the configuration information. The first type SIMD lane may include a single CEC. For example, in FIG. 3, each CEC may form a first type SIMD lane. In this example, the CECs may form sixteen SIMD lanes SL#0 through SL#15, corresponding to the optimal SIMD width for the loop region.

Also, in the first execution mode, the FUs of the CECs may be disconnected from each other or the outputs of the FUs of the CECs may not bypass output registers (208 for each), based on the configuration information. For example, in the case of SL#15, a register file controller 301 may load data of the SIMD memory 103 in a register file 302. In this example, the input unit 303 connects the output of the register file 302 to the input of FU#15 304. For example, the input unit 303 may select an input port connected to the register file 302 from among the input ports of the FU#15 304. Accordingly, the data loaded in the register file 302 may be provided to the FU#15 304. The FU#15 304 may process the data and may output the results of the processing to an output unit 305. The results of the processing may be output from the SL#15 via the output register 208 (shown in FIG. 2).

As described in this example, if the SIMD width for a detected loop region is equal to the number of CECs, the processor 101 may use the first execution mode to efficiently process the loop region without wasting resources.

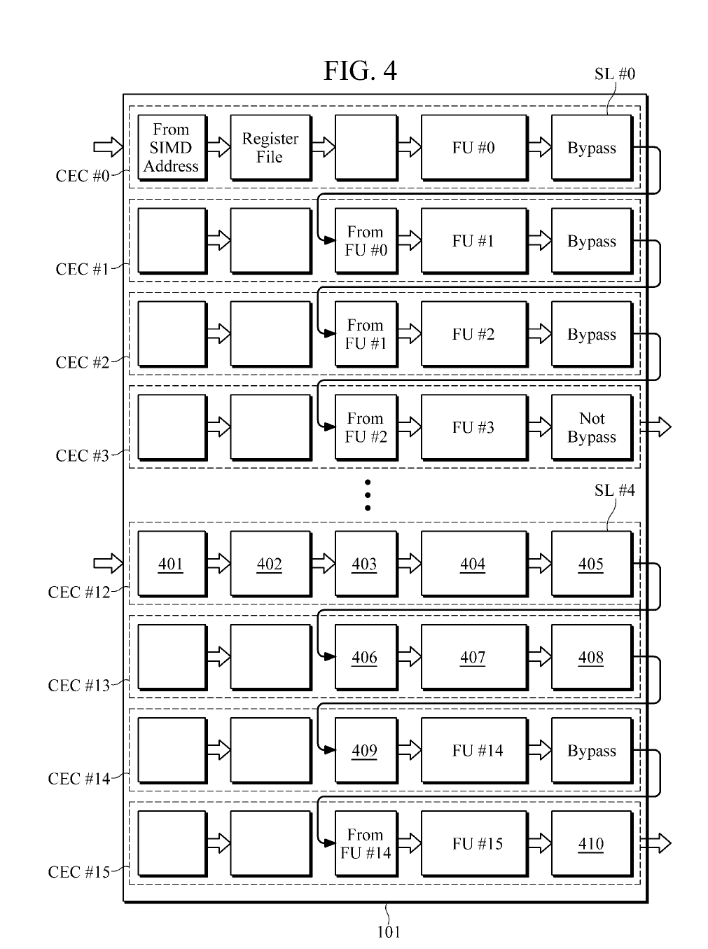

FIG. 4 illustrates an example of a computing apparatus that is in the second execution mode.

Referring to FIGS. 1 and 4, if an optimal SIMD width for a loop region is smaller than the number of CECs, the controller 102 may load configuration information corresponding to the second execution mode such that the processor 101 can process the loop region in the second execution mode.

The second execution mode, that is, in the narrow SIMD mode, the processor 101 may process the loop region using first or second type SIMD lanes according to the configuration information.

The first type SIMD lane has been described above with reference to FIG. 3. The second type SIMD lane may include a plurality of CECs that are chained. In the example illustrated in FIG. 4, CEC#0, CEC#1, CEC#2, and CEC#3 form SL#0. In the SL#0, the output of FU#0 is connected to the input of the FU#1, the output of FU#1 is connected to the input of FU#2, and the output of FU#2 is connected to the input of FU#3. In this example, the SIMD land SL#0 includes CEC#0, CEC#1, CEC#2, and CEC#3.

An example in which a loop region is processed using a second type SIMD lane in the second execution mode is described below. In the second execution mode, the FUs of CECs may be connected to each other or the output of a specific FU may be bypassed and provided as an input of another FU, based on the configuration information.

For example, in the case of SL#4, a register file controller 401 may load data of the SIMD memory 103 in a register file 402. An input unit 403 connects the output of the register file 402 to the input of a FU#12 404. For example, the input unit 403 may select an input port connected to the register file 402 from among input ports of the FU#12 404. Accordingly, the data loaded in the register file 402 is provided to the FU#12 404. The FU#12 404 may process the data and output the results of the processing to an output unit 405.

In this example, the results of the processing are provided to CEC#13 via a bypass 207 (shown in FIG. 2). That is, the results of the processing are bypassed such that the register file controller and the register file of CEC #13 are skipped. The input unit 406 of CEC#13 may select an input port connected to the output of the FU#12 404 from among the input ports of the FU#13 407. Accordingly, the results of the processing by the CEC#12 may be input to the CEC#13. Likewise, the results of processing by the FU#13 may be bypassed in an output unit 408 and provided to CEC#14, and the results of processing by the CEC#14 may be bypassed and input to CEC#15 and then output from SL#4 through the output unit of the CEC#15.

For example, if the SIMD width for a detected loop region is smaller than the number of CECs, the processor 101 may use the second execution mode that operates through a SIMD lane is in which a plurality of CECs are chained, thus more efficiently processing the loop region without wasting resources.

As another example, the loop region may be executed using the first SIMD lane in the second execution mode. For example, as illustrated in FIG. 3, by forming each SIMD lane using a single CEC and designating memory access locations of individual SIMD lanes to different locations in the second execution mode, a loop region may be processed in parallel in task level. For example, referring to FIG. 3, each of SL#0 through SL#15 may process a loop for an input#0 through input#15, independently.

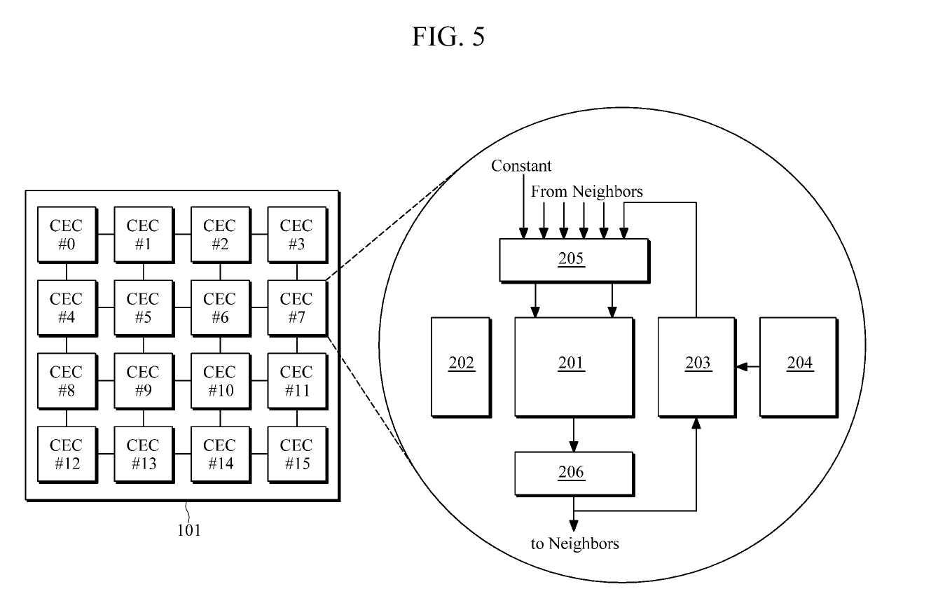

FIG. 5 illustrates an example of a computing apparatus that is in the third execution mode.

Referring to FIGS. 1 and 5, if a loop region is not subject to SIMD-ization, the controller 102 may load configuration information corresponding to the third execution mode so that the processor 101 can process the loop region in the third execution mode.

In the third execution mode, that is, in the non-SIMD mode, the processor 101 may process the loop region as a coarse-grained array (CGA) in which CECs are coupled, for example, in a tile form, in a mesh form, and the like, without using any SIMD lanes, based on configuration information. As an example, as illustrated in FIG. 5, CEC#5 may be connected to its neighbors CEC#1, CEC#4, CEC#6, and CEC#9. Connections between CECs may be defined based on configuration information of the configuration memory 202 and optimized according to the type of a loop.

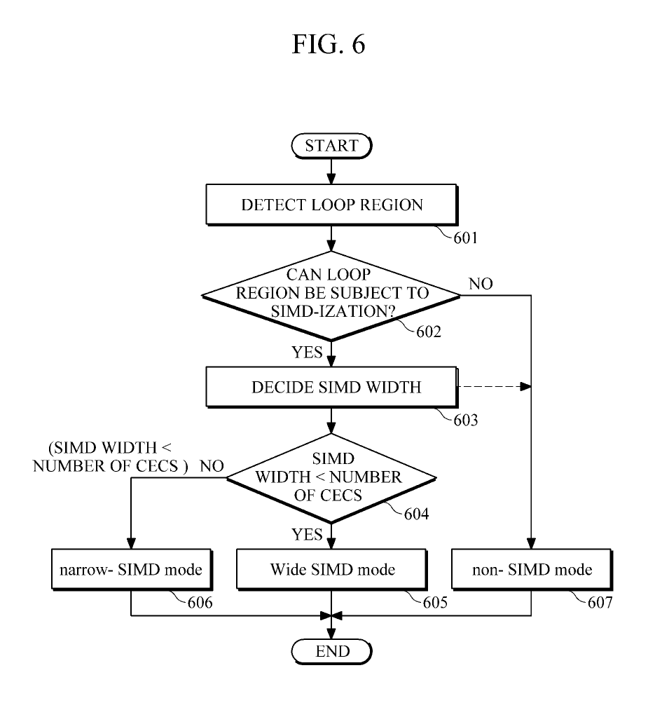

FIG. 6 illustrates an example of a computing method.

Referring to FIGS. 1 and 6, the computing apparatus 100 detects a loop region from a program that is to be executed (601).

In response to a loop region being detected, in 602 the computing apparatus 100 determines whether the detected loop region is to be subject to SIMD-ization (602). For example, the computing apparatus 100 may determine whether code correction is possible such that the loop region can be processed based on SIMD architecture.

In response to determining that the loop region can be subject to SIMD-ization, the computing apparatus 100 determines a SIMD width (603). For example, the controller 102 may set the number of processing units or datapaths to most quickly execute the loop region.

In response to an optimal SIMD width for the loop region being determined, whether the optimal SIMD width is equal to the number of CECs of the computing apparatus 100 is determined (604).

In response to the optimal SIMD width being equal to the number of CECs of the computing apparatus 100, the computing apparatus 100 executes the loop region in the wide SIMD mode (605). For example, as illustrated in FIG. 3, it is possible that each CEC may form a first type SIMD lane, and the loop region may be executed based on the first type SIMD lane.

In response to the optimal SIMD width being smaller than the number of CECs of the computing apparatus 100, the computing apparatus 100 executes the loop region in the narrow SIMD mode (606). For example, as illustrated in FIG. 4, a plurality of chained CECs may form a second type SIMD lane, and the loop region may be executed using the second type SIMD lane. Also, as illustrated in FIG. 3, the loop region may be executed in parallel in task level by differentiating memory access locations of first type SIMD lanes that are each composed of a single CEC.

Meanwhile, if the loop region is not subject to SIMD-ization, the computing apparatus 100 executes the loop region in the non-SIMD mode (607). For example, as illustrated in FIG. 5, each CEC may execute the loop region while operating as a processing core of a CGA.

According to various aspects, first and/or second type SIMD lanes may be formed according to a SIMD width, and a program may be executed in an execution mode according to the SIMD width. Accordingly, programs having various SIMD widths may be flexibly executed. Also, if a loop that is not subject to SIMD-ization can be processed through parallel processing by a plurality of CECs. Accordingly, it is possible to reduce resource wastes and quickly process loops.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A computing apparatus based on Single Instruction Multiple Data (SIMD) architecture, the computing apparatus comprising:
a processor including a plurality of configurable execution cores (CECs) which are capable of processing in a plurality of execution modes; and
a controller for detecting a loop region from a program, determining a Single Instruction Multiple Data (SIMD) width for the detected loop region, and determining an execution mode of the processor according to the determined SIMD width.

2. The computing apparatus of claim 1, wherein, in a first execution mode, the processor processes the loop region based on a first type SIMD lane comprising a single CEC.

3. The computing apparatus of claim 1, wherein, in a second execution mode, the processor processes the loop region based on a second type SIMD lane comprising a plurality of CECs that are chained to each other.

4. The computing apparatus of claim 1, wherein, in a third execution mode, the processor processes the loop region while operating as a coarse-grained array.

5. The computing apparatus of claim 1, wherein each CEC comprises:
a function unit (FU) for processing data; and
a configuration memory for storing configuration information corresponding to each execution mode.

6. The computing apparatus of claim 5, wherein each CEC further comprises:
a register file in which data is stored;
a register file controller for causing one of data stored in a SIMD memory and data stored in the configuration memory to be stored in the register file;
an input unit connected to an output of the register file or to an output of another CEC, and providing the FU with the data stored in the register file or data output from the other CEC; and
an output unit including an output register that stores output data from the FU, and a bypass for bypassing the output register.

7. The computing apparatus of claim 6, wherein the configuration information defines at least one of a connection relationship of the FUs, data input and output locations of each FU, a location of data that is to be loaded in the register file, and an activation/deactivation state of the bypass.

8. The computing apparatus of claim 5, wherein the controller loads configuration information corresponding to the decided execution mode in the configuration memory.

9. A computing method based on a Single Instruction Multiple Data (SIMD) architecture, the computing method comprising:
detecting a loop region from a program;
determining a Single Instruction Multiple Data (SIMD) width for processing the detected loop region; and
determining an execution mode of an array processor including a plurality of Configurable Execution Cores (CECs) based on the determined SIMD width.

10. The computing method of claim 9, wherein the execution mode comprises:
a first execution mode in which the array processor processes the loop region based on a first type SIMD lane comprising a single CEC;
a second execution mode in which the array processor processes the loop region based on a second type SIMD lane comprising a plurality of CECs that are chained to each other; and
a third execution mode in which the array processor processes the loop region while operating as a coarse-grained array.

11. A terminal comprising a Single Instruction Multiple Data (SIMD) architecture that is capable of processing instructions in a plurality of processing modes, the terminal comprising:
a plurality of processing elements for processing instructions; and
a controller for analyzing a loop region of a SIMD instruction to be processed, determining a number of processing elements to process the loop region to achieve a predetermined processing efficiency, and determining a processing mode from the plurality of processing modes based on the number of processing elements determined to process the loop region.

12. The terminal of claim 11, wherein a first processing mode comprises a SIMD wide mode in which each processing element of the plurality of processing elements simultaneously process a respective instruction.

13. The terminal of claim 11, wherein a second processing mode comprises a SIMD narrow mode in which at least two processing elements out of the plurality of processing elements simultaneously process the same instruction, and the at least two processing elements are chained to each other.

14. The terminal of claim 11, wherein a third processing mode comprises a coarse-grained array (CGA) mode.

15. The terminal of claim 11, wherein the controller determines the number of processing elements to process the loop region based on whether the loop region is subject to SIMD-ization.

16. The terminal of claim 15, wherein, in response to the controller determining the loop region is subject to SIMD-ization, the controller determines a SIMD width that corresponds to the number of processing elements that are determined to simultaneously process the loop region.
